(19) United States
(12) Patent Application Publication
(10) Pub. No.: US 2008/0198892 A1
(43) Pub. Date: Aug. 21, 2008

(54) Laser Pointer

(75) Inventor: Han-Chung Chiang, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei Hsien (TW)

(21) Appl. No.: 11/675,154

(22) Filed: Feb. 15, 2007

(51) Int. Cl. H01S 3/02

(52) U.S. Cl. 372/81

(57) ABSTRACT

A laser pointer has a body, a laser generator, a retractable cord assembly and an external-power interface. The laser generator is disposed on the body, and the retractable cord assembly is mounted in the body. The retractable cord assembly has an electrical cable having a first end coupled to the laser generator and a second end capable of selectively withdraw from the body. The external-power interface is connected to the second end of the electrical cable.

### BACKGROUND

1. Field of Invention

The present invention relates to a laser pointer. More particularly, the present invention relates to a laser pointer whose power is supplied by a computer.

2. Description of Related Art

A laser pointer is often used in teaching, lectures, or conferences for pointing out the subjects. The laser pointer is preferred to have a lightweight for better portability and operation. Therefore, the power supply of a conventional laser pointer always relies on a battery, which unfortunately generates the following drawbacks. Firstly, because the laser generator of the laser pointer, e.g. a laser diode, consumes a lot of power, the lifespan of the battery tends to be short. For this reason, power shortage is more likely to occur when the laser pointer is in use, which in turn will result in more battery replacements, and doing more battery replacements certainly means more inconvenience to the user. Besides, a large consumption of batteries means the cost of using a laser pointer will be increased, and a waste battery also increases the environmental pollution.

### SUMMARY

According to one embodiment of the present invention, the laser pointer comprises a body, a laser generator, a retractable cord assembly and an external-power interface. The laser generator is disposed on the body, and the retractable cord assembly is mounted in the body. The retractable cord assembly comprises an electrical cable having a first end coupled to the laser generator and a second end capable of selectively withdraw from the body. The external-power interface is connected to the second end of the electrical cable.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a laser pointer according to one embodiment of the present invention;

FIG. 2A is a laser pointer according to another embodiment of the present invention;

FIG. 2B is a laser pointer according to another embodiment of the present invention;

FIG. 3 is a laser generator of the laser pointer according to one embodiment of the present invention; and

FIG. 4 is side elevation view of the retractable cord assembly of the laser pointer according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

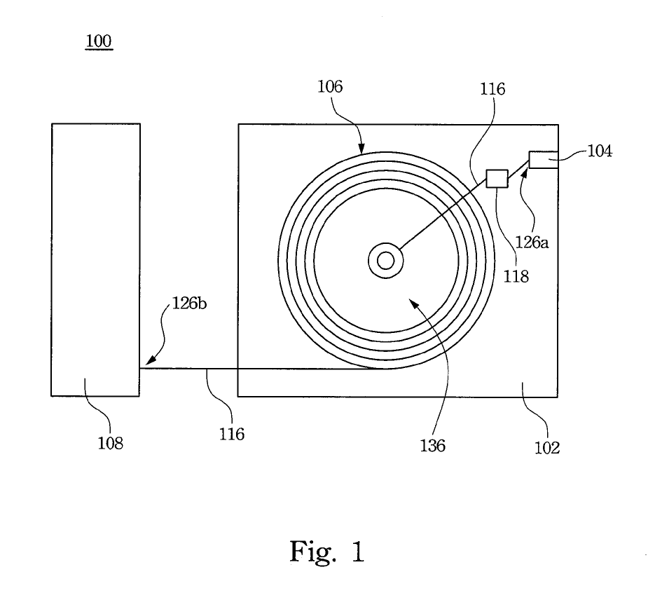

FIG. 1 is a laser pointer according to one embodiment of the present invention. The laser pointer 100 has a body 102, a laser generator 104, a retractable cord assembly 106 and an external-power interface 108. The laser generator 104 is disposed on the body 102, and the retractable cord assembly 106 is mounted in the body 102. The retractable cord assembly 106 has an electrical cable 116 having a first end 126a coupled to the laser generator 104 and a second end 126b capable of selectively withdraw from the body 102. The external-power interface 108 is connected to the second end 126b of the electrical cable 116. The external-power interface 108 allows the laser generator 104 to be powered by an external power (not shown).

More particularly, the laser generator 104 can has a laser diode or other suitable light generator which can generate a laser beam. A rechargeable battery 118 couples the electrical cable 116 to store electrical power which can be supplied to the laser generator 104 while the external power supplying is absent. The rechargeable battery 118 can be a Li-ion battery, which may be coupled between the laser generator 104 and the external-power interface 108 as illustrated in FIG. 1, or directly coupled onto the electrical cable 116 (not illustrated). The external-power interface 108 can be an interface of USB, an interface of IEEE 1394, an interface of PS/2 or an interface of PCMCIA, which is arranged to connect a corresponding connector provided from a computer, such as a personal computer, a notebook computer or a digital personal assistant (PDA).

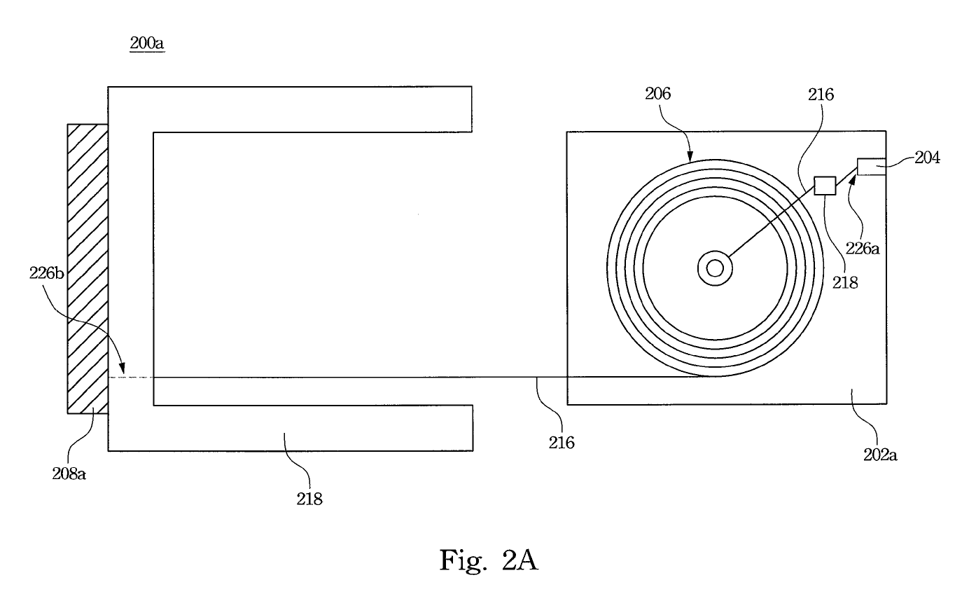

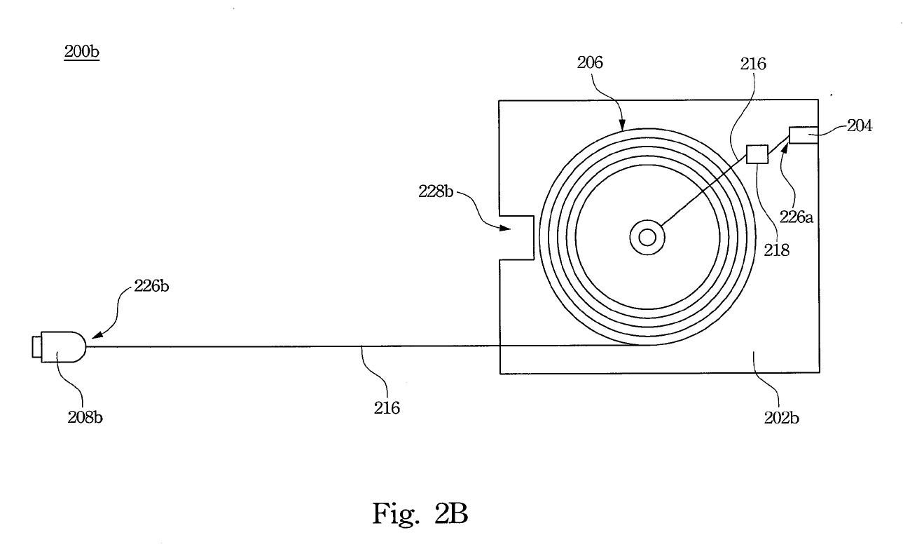

FIG. 2A depicts a laser pointer 200a according to another embodiment of the present invention. The laser pointer 200a has a body 202a, a laser generator 204, a retractable cord assembly 206 and an interface of PCMCIA 208a. The laser generator 204 is disposed on the body 202a, and the retractable cord assembly 206 is mounted in the body 202a. The retractable cord assembly 206 has an electrical cable 216 having a first end 226a coupled to the laser generator 204 and a second end 226b capable of selectively withdraw from the body 202a. The interface of PCMCIA 208a is connected to the second end 226b of the electrical cable 216.

A rechargeable battery 218 couples the electrical cable 216 to store electrical power which can be supplied to the laser generator 204 while the external power supplying is absent. The interface of PCMCIA 208a can be used to connect to a corresponding connector of a computer, such as a PCMCIA port of a notebook computer. The laser pointer 200a further has an adapter 218 which is capable of being accommodated in a PCMCIA slot. The interface of PCMCIA 208a is mounted on the adapter 218, and the body 202a is capable of plugging into the adapter 218. By this configuration, the laser pointer 200a can be hold on a user's hand by pulling the body 202a out from the adapter 218, and be kept in the notebook computer by plugging the body 202a into the adapter 218a as well as inserting the adapter 218 into the PCMCIA port of the notebook computer.

FIG. 2B depicts a laser pointer 200b according to another embodiment of the present invention. The laser pointer 200b has a body 202b, a laser generator 204, a retractable cord assembly 206 and an interface of USB 208b. The laser generator 204 is disposed on the body 202b, and the retractable cord assembly 206 is mounted in the body 202b. The retractable cord assembly 206 has an electrical cable 216 having a first end 226a coupled to the laser generator 204 and a second end 226b capable of selectively withdraw from the body 202b. The interface of USB 208b is connected to the second end 226b of the electrical cable 216. The body 202b further has a slot 228b for containing the interface of USB 208b when the electrical cable 216 is retracted back into the body 202b.

A rechargeable battery 218 couples the electrical cable 216 to store electrical power which can be supplied to the laser generator 204 while the external power supplying is absent. The interface of USB 208b, such as a type-A USB plug, a type-B USB plug, a Mini-A USB plug or a Mini-B USB plug, can be used to connect to a corresponding connector of a computer, such as a USB receptacle of a computer or a USB hub. By this configuration, the laser pointer 200b can be easily supplied power from the computer through the popular USB interface almost configured on every computer.

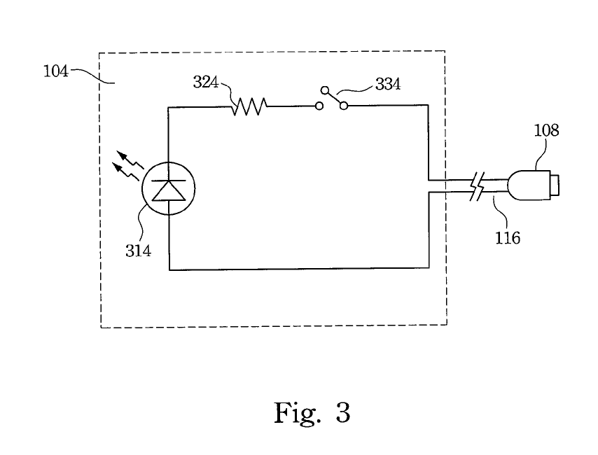

FIG. 3 depicts a laser generator 104 shown in FIG. 1 according to one embodiment of the present invention. The laser generator 104 includes a laser diode 314, a power switch 334, and a current limiting resistor 324. The laser diode 314 is to generate laser beams. An external-power interface 108 is coupled to a power supply device, such as a computer, and the power supply device is to provide power to the laser generator 104 through an electrical cable 116. The power switch 334 is connected between the laser diode 314 and the external-power interface 108, and when in use, the power switch 334 will conduct power from the power supply device to the laser diode 314. In addition, the current limiting resistor 324 is also connected between the laser diode 314 and the external-power interface 108 to protect the laser diode 314 from damage caused by the current-overload of the laser generator 104.

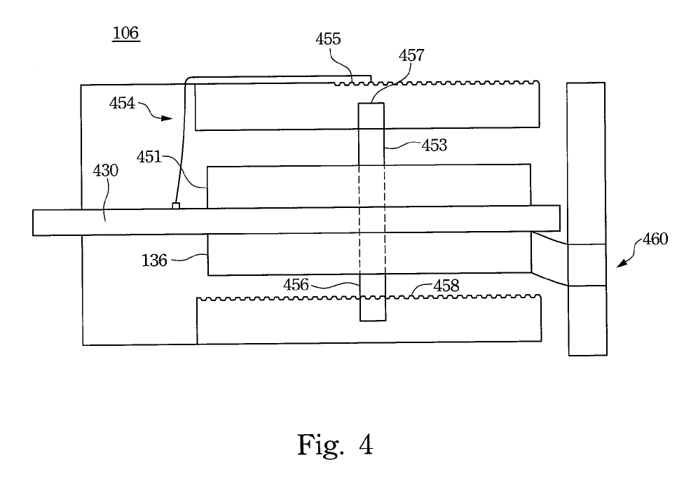

Referring to FIG. 1, the retractable cord assembly 106 has a storage reel 136, which is mounted in the body 102. FIG. 4 further shows side elevation view of the retractable cord assembly 106 shown in FIG. 1 according to one embodiment of the present invention. The retractable cord assembly 106 includes a storage reel 136 capable of neatly storing the electrical cable (not shown) wound thereon; a spring storage reel or cartridge 451 within which a helical, circular, or other spring can be neatly stored; and a mounting arbor 453.

The storage reel 136 and spring storage cartridge 451 can be mounted on the arbor 453. The arbor 453 may pass through an opening (not shown) in a supporting board 430. Alternatively, the supporting board 430 may be so designed as not to extend into the area 454. Slip rings or bushings 455, 456 mount the arbor 453 in openings 457, 458 in the respective cover parts of the body 102 shown in FIG. 1. The arbor 453 extends generally perpendicularly with respect to the major substantially planar extents of the cover parts of the body and the storage reel 136 and spring cartridge 451 are mounted so that as they rotate, such rotation is generally in parallel with the plane of the supporting board 430 without rubbing against the supporting board 430.

Referring to FIGS. 1 and 4, as the electrical cable 106 is pulled out of the body 102, the storage reel 136, spring cartridge 451, and arbor 453 rotate clockwise or counterclockwise. During such rotation the spring 452 is tightened. As the electrical cable 106 is drawn back into the body 102, under the force influence of the spring 452, the arbor 453, the storage reel 136 and the spring cartridge 451 rotate counterclockwise or clockwise.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A laser pointer, comprising:
a body;
a laser generator disposed on the body;
a retractable cord assembly mounted in the body, wherein the retractable cord assembly comprising:
an electrical cable having a first end coupled to the laser generator and a second end capable of selectively withdraw from the body; and
an external-power interface connected to the second end of the electrical cable.

2. The laser pointer as claimed in claim 1, wherein the laser generator comprises a laser diode.

3. The laser pointer as claimed in claim 1, wherein the external-power interface is an interface of USB, an interface of IEEE 1394, an interface of PS/2 or an interface of PCMCIA.

4. The laser pointer as claimed in claim 1, wherein the external-power interface is an interface of PCMCIA, the laser pointer further comprises:
an adapter capable of being accommodated in a PCMCIA slot, wherein the interface of PCMCIA is mounted on the adapter, and the body is capable of plugging into the adapter.

5. The laser pointer as claimed in claim 1, wherein the laser generator comprising:
a current limiting resistor connected to the external-power interface to protect the laser generator from damage caused by the current-overload of the laser generator; and
a power switch connected to the external-power interface to conduct power to the laser generator.

6. The laser pointer as claimed in claim 1, wherein the retractable cord assembly further comprises:
a storage reel mounted in the body; and
a mounting device for mounting the storage reel for rotation in the body for withdrawing the electrical cable from the storage reel and for drawing the electrical cable back onto the storage reel to retract the electrical cable back into the body.

7. The laser pointer as claimed in claim 1, wherein the body is capable of being accommodated in a PCMCIA slot.

8. The laser pointer as claimed in claim 1, wherein the body has a slot for containing the external-power interface when the electrical cable is retracted back into the body.

9. A laser pointer, comprising:
a body;
a laser generator disposed on the body;
a retractable cord assembly mounted in the body, wherein the retractable cord assembly comprising:
an electrical cable having a first end coupled to the laser generator and a second end capable of selectively withdraw from the body; and
an interface of PCMCIA connected to the second end of the electrical cable; and
an adapter capable of being accommodated in a PCMCIA slot, wherein the interface of PCMCIA is mounted on the adapter, and the body is capable of plugging into the adapter;
wherein the laser generator further comprises:
a current limiting resistor connected to the interface of PCMCIA to protect the laser generator from damage caused by current-overload of the laser generator; and
a power switch connected between the laser generator and the interface of PCMCIA to conduct power to the laser generator.

10. The laser pointer as claimed in claim 9, wherein the laser generator comprises a laser diode.

11. The laser pointer as claimed in claim 9, wherein the external-power interface is an interface of USB, an interface of IEEE 1394, an interface of PS/2 or an interface of PCMCIA.

12. The laser pointer as claimed in claim 9, wherein the retractable cord assembly further comprises:
a storage reel mounted in the body; and
a mounting device for mounting the storage reel for rotation in the body for withdrawing the electrical cable from the storage reel and for drawing the electrical cable back onto the storage reel to retract the electrical cable back into the body.
